(19) United States
(12) Patent Application Publication
(10) Pub. No.: US 2025/0388059 A1
(43) Pub. Date: Dec. 25, 2025

(54) SYSTEMS AND METHODS FOR IDEA INCUBATION DURING A COMMUTE

(71) Applicant: Toyota Research Institute, Inc., Los Altos, CA (US)

(72) Inventors: Pablo E. Paredes, San Leandro, CA (US); Shabnam Hakimi, San Francisco, CA (US); Matthew K. Hong, Mountain View, CA (US); Matthew E. Klenk, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/976,524

(22) Filed: Dec. 11, 2024

Related U.S. Application Data
(60) Provisional application No. 63/661,863, filed on Jun. 19, 2024.

(51) Int. Cl. B60H 1/00

(52) U.S. Cl. CPC B60H 1/0073; B60H 2001/00733

(57) ABSTRACT

Systems, methods, and other embodiments described herein relate to idea incubation during a commute. In one embodiment, a method includes, in response to identifying one or more conditions where an occupant of a vehicle is capable of commuting and participating in idea incubation, communicating with the occupant about one or more ideas. The method also includes storing information received from the occupant based on the one or more ideas.

### CROSS-REFERENCE TO RELATED APPLICATIONS/INCORPORATION BY REFERENCE

This patent application makes reference to, claims priority to, and claims benefit from U.S. Provisional Application Ser. No. 63/661,863, titled “Creative Commuter: Towards Designing Idea Generation and Incubation Moments for Commuters” filed on Jun. 19, 2024; which is hereby incorporated herein by reference in its entirety.

### FIELD

The subject matter described herein relates in general to idea incubation with an occupant of a vehicle during a vehicle commute.

### BACKGROUND

Commuters spend a significant amount of time traveling from home to work or school. During this time, commuters are unable to participate in certain activities without compromising driving safety.

### SUMMARY

This section generally summarizes the disclosure and is not a comprehensive explanation of its full scope or all its features.

In one embodiment, a system for idea incubation with an occupant of a vehicle during a vehicle commute is disclosed. The system includes a processor and a memory in communication with the processor. The memory stores machine-readable instructions that, when executed by the processor, cause the processor to, in response to identifying one or more conditions where an occupant of a vehicle is capable of commuting and participating in idea incubation, communicate with the occupant about one or more ideas. The memory stores machine-readable instructions that, when executed by the processor, cause the processor to store information received from the occupant based on the one or more ideas.

In another embodiment, a method for idea incubation with an occupant of a vehicle during a vehicle commute is disclosed. The method includes, in response to identifying one or more conditions where an occupant of a vehicle is capable of commuting and participating in idea incubation, communicating with the occupant about one or more ideas. The method includes storing information received from the occupant based on the one or more ideas.

In another embodiment, a non-transitory computer-readable medium for idea incubation with an occupant of a vehicle during a vehicle commute and including instructions that, when executed by a processor, cause the processor to perform one or more functions, is disclosed. The instructions include instructions to, in response to identifying one or more conditions where an occupant of a vehicle is capable of commuting and participating in idea incubation, communicate with the occupant about one or more ideas. The instructions include instructions to store information received from the occupant based on the one or more ideas.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating an idea incubation control system.

FIG. 2 is a more detailed block diagram of the idea incubation control system of FIG. 1.

FIG. 3 is an example of a method for idea incubation with an occupant of a vehicle during a vehicle commute.

### DETAILED DESCRIPTION

Systems, methods, and other embodiments associated with idea incubation during a commute are disclosed. Commuters spend a significant amount of time in vehicles, traveling from home to work (or school) and back. While enroute to work or back home, the focus level of a commuter driving a vehicle may vary. At certain times and locations, the commuter may be required to have a higher focus level on driving and vehicle operation. At other times and locations, the commuter may be capable of driving and vehicle operation with a lower focus level. In other words, the cognitive load and arousal level of the commuter in relation to driving and vehicle operation may vary based on, as an example, traffic level, traffic conditions, road type, and/or driving expertise of the commuter. As such, at certain times when the cognitive load and arousal level of the commuter is low, the commuter may be receptive to and capable of engaging in idea incubation and idea development.

Current methods include emotion regulation tools and stress management tools. However, none of these methods or tools aid a commuter in idea incubation and/or idea development by providing idea prompts to the commuter as well as interacting with the commuter such as providing various options on the proposed ideas and assisting the commuter in refining the proposed ideas.

Accordingly, systems, methods, and other embodiments associated with idea incubation during a commute are disclosed. The system integrates psychological interventions tailored for driving and draws on automated driving advancements to ensure safety and effectiveness. Using a context-aware sensing framework, the system times interventions during appropriate driving scenarios so as to minimize distraction. The system obtains context data from car sensors and employs generative artificial intelligence (AI) to deliver subtle interventions, enhancing occupant engagement and idea output without compromising safety. The system includes an evaluation that measures occupant engagement and post-commute reports to determine an impact on and/or quality level of idea generation and driving performance. The system integrates creativity support tools into daily commutes, which potentially transforms in-car intelligence systems and enhances productivity and innovation capabilities.

The system utilizes psychological and immersive techniques in a vehicle to incubate new ideas that can be useful in design, innovation, problem-solving, and critical design jobs. Commute driving has a lower cognitive cost for commuters, who are used to the same driving course daily. As such, idea incubation can happen in parallel to commute driving.

The system determines a cognitive load and arousal of a commuter based on various conditions such as traffic conditions, road conditions, time of day, the presence of cyclists and pedestrians, autonomous vehicle operation, etc. The system also determines the cognitive load of the commuter based on characteristics of the commuter such as driving skill level, emotional state, driving style, interaction with other commuters in the vehicle, etc. The system may determine the various conditions and the characteristics of the commuter using sensors and based on historical information.

Upon determining the cognitive load and arousal level of the commuter, the system may further determine whether the cognitive load of the commuter is less than a predetermined threshold value. The predetermined threshold value may be determined using any suitable algorithm, such as machine learning and/or artificial intelligence (AI) techniques. In response to determining that the cognitive load and/or arousal level of the commuter are less than the predetermined threshold value, the system may set up a creative environment for idea incubation. The creative environment may include a suite of embodied subtle interactions, such as sounds, music, conversations, and other mild interventions that do not affect driving safety even though driving performance may be slightly reduced. The system may deliver interventions generated by generative AI within the vehicle using different modalities such as sound, light, display, vibration, and/or scent, coupled or not with a conversational agent. The intervention may include an idea prompt based on a contextual reinforcement learning (RL) algorithm that measures data from the vehicle using an On-Board Diagnostics (OBD) dongle, the commuter(s) using sensors such as internal cameras, passive sensors, steering wheel sensors, environmental conditions using sensors such as external cameras. Based on the data, the system may determine when to recommend just-in-time interventions. The system may present the intervention to the commuter(s) using, as an example, a voice-activated or a multimedia display interaction. After an idea incubation session is completed, the system may evaluate the effectiveness of the session based on, as an example, the commuter engagement, the number of ideas expressed, the type of ideas, the quality of the ideas such as the level of details within the ideas, and also based on whether driving safety was impacted by the idea incubation session. As an example, the system may record whether there was any severe lane deviation and/or hard braking during the idea incubation session. The system may develop a report based on the ideas and provide the report to the commuter and/or a third party in any suitable format, as an example, a messaging application, a database, a spreadsheet, or a word processing application.

In summary, the system determines whether to activate one or more in-vehicle interactions based on vehicle data, occupant state, and/or low driving focus periods. The vehicle data refers to conditions and/or the state of the vehicle which can be retrieved from vehicle systems such as a steering wheel, sensors such as internal cameras and external cameras, vehicle pedals such as gas pedal and brake pedal, and/or the speedometer. Vehicle data may include the velocity and/or acceleration of the vehicle, the location of the vehicle, the direction of travel of the vehicle, the temperature and/or humidity levels inside the vehicle. Vehicle data may further include environmental conditions such as weather conditions, road conditions, and/or visibility conditions.

The occupant state refers to the conditions and/or state of the occupant, which may be retrieved sensors such as biometric sensors and sensors capable of monitoring the heart rate, the eye movement, the muscle tension, and/or the muscle movement of the occupant. The low driving focus periods refer periods when the occupant is not actively focused on driving (or ‘mindlessly driving’).

The one or more in-vehicle interactions may include a suite of just-in-time interactions, which be regular or generative AI enhanced just-in-time interactions. The system may utilize, as an example, a multi-armed bandit solution and/or a generative AI large language module to select and activate just-in-time interactions relating to idea generation and immersive scenarios relating to light levels and colors, videos, sound, wind, and/or touch.

It will be appreciated that arrangements described herein can provide numerous benefits, including one or more of the benefits mentioned herein. For example, arrangements described herein may aid an occupant of a vehicle in generating and/or developing one or more ideas. Arrangements described herein assist the occupant in exploiting commute time, multi-tasking, and making commute time more productive while maintaining driving safety. Arrangements described herein may provide business value within in-car intelligence systems such as advanced driver assistance system (ADAS). Arrangements described herein can provide a creative and private environment for idea incubation as the vehicle is an enclosed environment.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

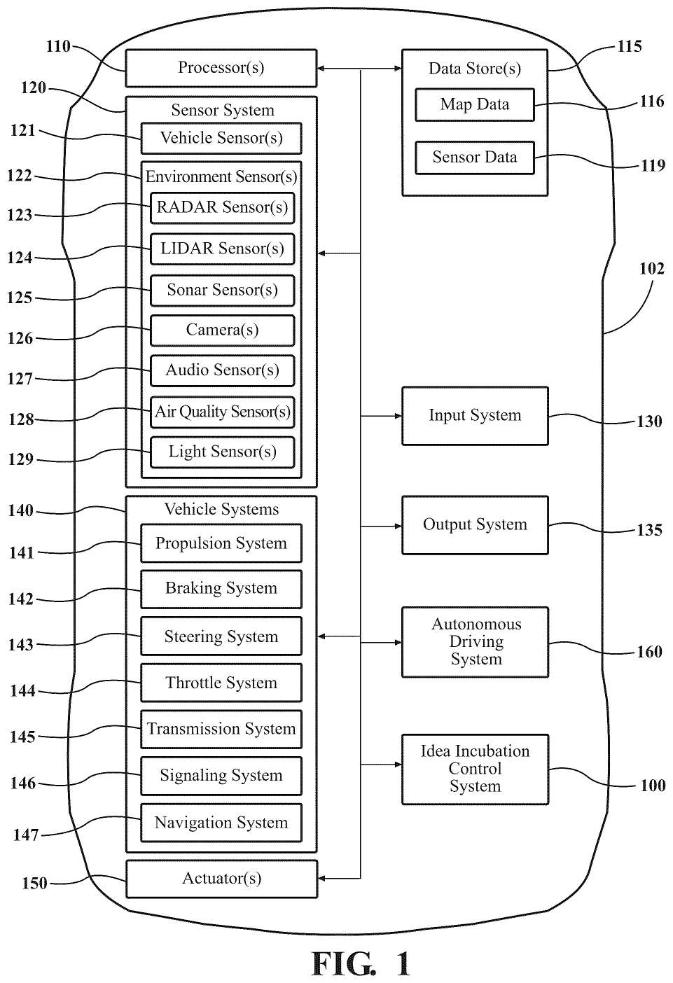

Referring to FIG. 1, a block diagram of a vehicle 102 incorporating an idea incubation control system 100 is illustrated. The vehicle 102 includes various elements. It will be understood that in various embodiments, it may not be necessary for the vehicle 102 to have all of the elements shown in FIG. 1. The vehicle 102 can have any combination of the various elements shown in FIG. 1. Further, the vehicle 102 can have additional elements to those shown in FIG. 1. In some arrangements, the vehicle 102 may be implemented without one or more of the elements shown in FIG. 1. While the various elements are shown as being located within the vehicle 102 in FIG. 1, it will be understood that one or more of these elements can be located external to the vehicle 102. Further, the elements shown may be physically separated by large distances. For example, as discussed, one or more components of the disclosed system can be implemented within a vehicle while further components of the system can be implemented within a cloud-computing environment.

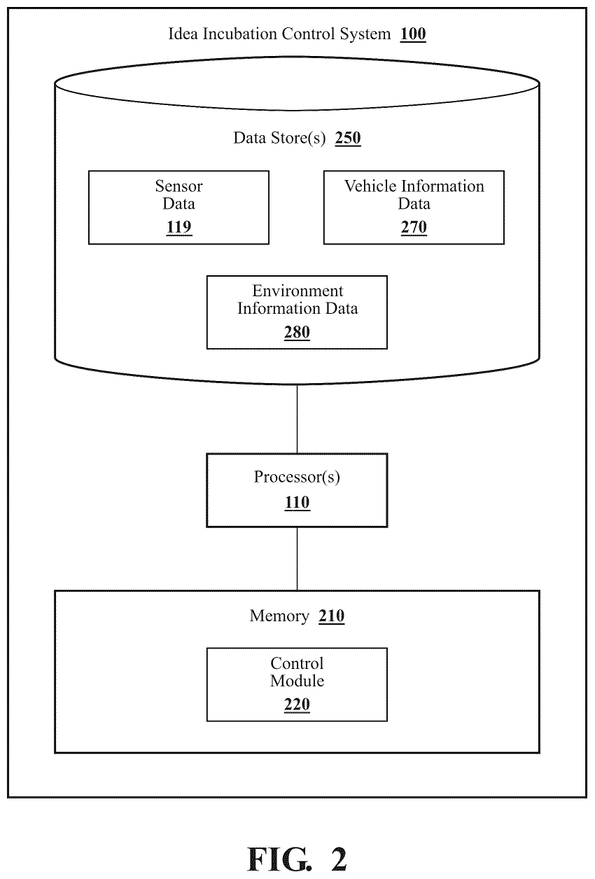

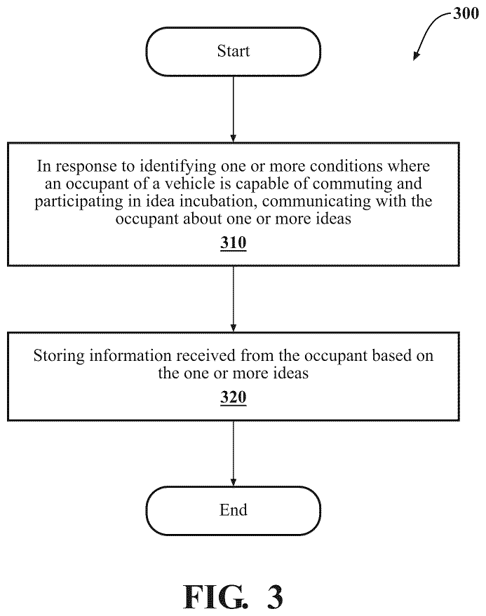

Some of the possible elements of the vehicle 102 are shown in FIG. 1 and will be described along with subsequent figures. However, a description of many of the elements in FIG. 1 will be provided after the discussion of FIGS. 2-3 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 102 includes the idea incubation control system 100 that is implemented to perform methods and other functions as disclosed herein relating to idea incubation with an occupant of a vehicle 102 during a vehicle commute. As an example, the idea incubation control system 100, in various embodiments, may be implemented partially within the vehicle 102 and may further exchange communications with additional aspects of the idea incubation control system 100 that are remote from the vehicle 102 in support of the disclosed functions. Thus, while FIG. 2 generally illustrates the idea incubation control system 100 as being self-contained, in various embodiments, the idea incubation control system 100 may be implemented within multiple separate devices, some of which may be remote from the vehicle 102.

With reference to FIG. 2, a more detailed block diagram of the idea incubation control system 100 is shown. The idea incubation control system 100 may include a processor(s) 110. Accordingly, the processor(s) 110 may be a part of the idea incubation control system 100, or the idea incubation control system 100 may access the processor(s) 110 through a data bus or another communication pathway. In one or more embodiments, the processor(s) 110 is an application-specific integrated circuit that may be configured to implement functions associated with a control module 220. More generally, in one or more aspects, the processor(s) 110 is an electronic processor, such as a microprocessor that can perform various functions as described herein when loading the control module 220 and executing encoded functions associated therewith.

The idea incubation control system 100 may include a memory 210 that stores the control module 220. The memory 210 may be a random-access memory (RAM), read-only memory (ROM), a hard disk drive, a flash memory, or other suitable memory for storing the control module 220. The control module 220 includes, for example, computer-readable instructions that, when executed by the processor(s) 110, cause the processor(s) 110 to perform the various functions disclosed herein. While, in one or more embodiments, the control module 220 includes instructions embodied in the memory 210, in further aspects, the control module 220 includes hardware, such as processing components (e.g., controllers), circuits, etc. for independently performing one or more of the noted functions.

The idea incubation control system 100 may include a data store(s) 250 for storing one or more types of data. Accordingly, the data store(s) 250 may be a part of the idea incubation control system 100, or the idea incubation control system 100 may access the data store(s) 250 through a data bus or another communication pathway. The data store(s) 250 is, in one embodiment, an electronically based data structure for storing information. In at least one approach, the data store 250 is a database that is stored in the memory 210 or another suitable medium, and that is configured with routines that can be executed by the processor(s) 110 for analyzing stored data, providing stored data, organizing stored data, and so on. In either case, in one embodiment, the data store 250 stores data used by the control module 220 in executing various functions. In one embodiment, the data store 250 may be able to store sensor data 119, vehicle information data 270, environment information data 280, and/or other information that is used by the control module 220.

The data store(s) 250 may include volatile and/or non-volatile memory. Examples of suitable data stores 250 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 250 may be a component of the processor(s) 110, or the data store(s) 250 may be operatively connected to the processor(s) 110 for use thereby. The term “operatively connected” or “in communication with” as used throughout this description, can include direct or indirect connections, including connections without direct physical contact.

In one or more arrangements, the data store(s) 250 can include sensor data 119. The sensor data 119 can originate from the sensor system 120 of the vehicle 102. The sensor data 119 can include data from environment sensor(s) 122 such as visual sensors, audio sensors, and/or any other suitable sensors in the vehicle 102 capable of monitoring occupant(s).

In one or more arrangements, the data store(s) 250 can include vehicle information data 270. The vehicle information data 270 can include driver information such as occupant identification and occupant history. The occupant history can include the occupant's physiology and occupant's driving style. The occupant's driving style can include whether the occupant is light-footed or heavy footed on the brake pedal and/or the acceleration pedal, whether the occupant makes sharp turns, gradual turns, sudden turns, or slow turns when steering.

The vehicle information data 270 may include information about the control mode that the vehicle 102 is in. As an example, the vehicle 102 can be in a non-autonomous mode, a semi-autonomous mode, or an autonomous mode. As another example, one or more of the vehicle systems 140 in the vehicle 102 can be at varying levels of manual or autonomous control. In such an example, one or more of the steering system 143, the throttle system 144, and/or the braking system 142 can be under manual control, autonomous control, or somewhere in between.

In one or more arrangements, the data store(s) 250 can include environment information data 280. The environment information data 280 may include information about the environment surrounding the vehicle 102 such as the location and condition of the road that the vehicle 102 is travelling on. The location of the road(s) may include geographic coordinates of the road and the position of the road relative to a destination. The condition of the road may include traffic levels (including vehicles, cyclists, and/or pedestrians) on or along the road as well as traffic rules based on the jurisdiction at the location of the road. The condition of the road can include information about the physical condition of the road such as the presence of potholes, road debris, vegetation, occlusions and/or the presence of road delineators such as lane markers, road edge markers, traffic signs, traffic lights, and communicative roadside units.

Additionally and/or alternatively, the environment information data 280 can include conditions in the environment such as a weather condition, a road condition, air quality, light levels, and/or a timestamp. A weather condition may include, as an example, presence of precipitation such as snow, rain, and/or hail. The weather condition may further include impacts of weather such as fog levels, fallen snow levels (i.e. the amount of snow on the ground), and/or flooding. The air quality may include dust and/or pollen levels in the air. The light levels may include the brightness of light inside and/or around the vehicle 102. The environment information data 280 may be updated periodically and/or on-demand. The sensor data 119, the vehicle information data 270, and the environment information data 280 may be digital data that describe information used by the idea incubation control system 100 to control a vehicle system 140.

In one embodiment, the control module 220 may include instructions that, when executed by the processor(s) 110, cause the processor(s) 110 to, in response to identifying one or more conditions where an occupant of a vehicle 102 is capable of commuting and participating in idea incubation, communicate with the occupant about one or more ideas. The one or more conditions may include an environmental condition. Additionally and/or alternatively, the one or more conditions may include a condition of the occupant. The condition may be based on information collected from a sensor mounted within the vehicle 102. The environmental condition may refer to a condition inside the vehicle 102 and/or a condition outside the vehicle 102. As an example, a condition inside the vehicle 102 may include whether there are additional occupants in the vehicle 102. The control module 220 may receive sensor data 119 from sensors 121 in the vehicle 102 such as seat sensors or cameras that may detect whether there are additional occupants in the vehicle 102. As another example, a condition inside the vehicle 102 may include temperature and/or humidity levels. The control module 220 may receive the temperature and/or the humidity levels from sensors such as thermometers and/or hygrometers in the vehicle, respectively. Another condition inside the vehicle may be related to an autonomous operation of the vehicle. In such a case and as an example, the vehicle may be operating manually, semi-autonomously, or fully autonomously. The control module 220 may communicate with the vehicle using an electronic signal to request and receive information from the vehicle about whether the vehicle is operating manually, semi-autonomously, or fully autonomously.

As an example, a condition outside the vehicle 102 may include a location of the vehicle 102 and/or characteristics of the location of the vehicle 102. In such an example, the location may be a highway or a side road. Characteristics of the location may include traffic levels at the location, speed limits at the location, current speed of travel of the vehicle 102 and surrounding vehicles, whether there is construction at the location or a detour at the location, a presence of pedestrians and/or cyclists, proximity to a school or a hospital, and/or road conditions such as wet roads, snow-covered roads, or flooded roads. Conditions outside the vehicle 102 may also include time of day and/or current weather conditions. The control module 220 may receive, determine, and/or identify a condition outside of the vehicle 102 based on sensor data 119 from sensors 121, 122 mounted on the vehicle 102 or sensors mounted on road infrastructure such as traffic lights and road signs. The control module 220 may also determine a condition outside the vehicle 102 such as traffic levels from historical information stored in a database such as a third-party traffic information database. In such a case, the control module 220 may request and receive historical traffic information from the third-party traffic information database.

The condition of the occupant may include a skill level of the occupant. The skill level of the occupant may refer to the driving experience of the occupant. As an example, the control module 220 may determine whether the occupant is capable of driving and participating in idea incubation based on the number of years the occupant has been driving and/or whether, in the past, the occupant has successfully driven and participated in idea incubation. The condition of the occupant may further include whether the occupant is capable of participating in idea incubation with one or more additional occupants in the vehicle. In general, the condition of the occupant may include an ability of the occupant to multi-task.

The condition of the occupant may include an emotional state of the occupant. The control module 220 may request and receive information from the occupant regarding the emotional state of the occupant. Additionally and/or alternatively, the control module 220 may determine the emotional state of the occupant based on the sensor data 119 from sensors 121, 122 such as cameras, microphones, and/or heart monitors within the vehicle. The control module 220 may determine, from the sensor data 119, whether the occupant is angry, happy, sad, tired, currently crying, or has been crying. The control module 220 may utilize any suitable imaging techniques or tools to make such a determination. The control module 220 may determine the emotional state of the occupant based on the driving style of the occupant. In such a case, the control module 220 may receive information relating to how the occupant is gripping the steering wheel or gear stick, how fast the occupant is driving, how aggressively the occupant is driving, accelerating, decelerating or braking, changing gears, and/or changing lanes. The control module 220 may determine the emotional state of the occupant using such information and any suitable machine learning methods and/or artificial intelligence techniques.

The control module 220 may request and receive a condition from the occupant. In such a case and as an example, the occupant may enter information relating to a condition using an application, a keyboard, and/or an input screen. The control module 220 may inquire from the occupant whether the occupant would like to participate in an idea incubation session during the commute.

The control module 220 may communicate with one or more applications on the occupant's computer or mobile device. As an example, the control module 220 may determine, based on a number of email messages in the occupant's computer or mobile device, that the occupant may like to participate in idea incubation on a commute. The control module 220 may further access a calendar application, a project status application, a phone application, or an internet browser to infer whether the occupant will be interested in idea incubation on a commute.

In one embodiment, the control module 220 may include instructions that, when executed by the processor(s) 110, cause the processor(s) 110 to determine, based on an expected travel route of the vehicle, an expected cognitive load and arousal level of the occupant.

The control module 220 may determine the cognitive load and arousal level of the occupant based on one or more of the conditions mentioned above. In other words and as an example, the control module 220 may determine how much concentration the occupant requires to operate the vehicle 102 based on one or more of the conditions mentioned above such as the location of the vehicle 102 along a route, the time of day, traffic levels, pedestrian presence, cyclist presence, proximity to schools, playgrounds, hospitals, weather conditions, skill level of the occupant, emotional state of the occupant, the presence of additional occupants in the vehicle 102, ability of the occupant to multi-task, and/or occupant input. The control module 220 may utilize any suitable method such as machine learning techniques, artificial intelligence methods, algorithms, and/or look-up tables to determine the cognitive load and arousal level of the occupant based on the conditions.

The control module 220 may further include instructions that, when executed by the processor(s) 110, cause the processor(s) 110 to, when the expected cognitive load and arousal level of the occupant is below a threshold, communicate with the occupant about the one or more ideas. Upon determining the amount of concentration the occupant requires to operate the vehicle based on the one or more conditions, the control module 220 may determine whether the amount of concentration is less than a threshold value such that the occupant does not need to be highly focused or vigilant at a certain instance. In other words, the cognitive load and arousal level of the occupant based on the conditions may be low and so the occupant may be capable of operating the vehicle 102 and participating in idea incubation.

The control module 220 may determine the threshold value based on the occupant and the characteristics of the occupant. More generally, the control module 220 may determine the threshold value based on one or more of the environmental conditions and/or the conditions of the occupant. The control module 220 may utilize any suitable algorithms, functions, machine learning methods, and/or artificial intelligence techniques to determine the threshold.

In one embodiment, the control module 220 may include instructions that, when executed by the processor(s) 110, cause the processor(s) 110 to set up an environment inside a vehicle 102 conducive for idea incubation. As an example, the control module 220 may determine a temperature, a light level, a light color, a scent, a humidity level, an air movement level, a sound type, and/or sound level that is conducive for the occupant during idea incubation. The control module 220 may utilize any suitable algorithm, historical data, occupant input, machine learning methods, and/or artificial intelligence techniques to determine one or more of the temperature, a light level, a light color, a scent, a humidity level, an air movement level, a sound type, and/or sound level. Upon determining that the occupant would like to participate in idea incubation, the control module 220 may then set up the environment inside the vehicle 102, making the environment conducive for idea incubation for the occupant. As such, the environment may be customized to the occupant. The control module 220 may also determine that a previously customized environment is no longer suitable for the occupant or conducive for idea incubation with the occupant based on occupant input, occupant feedback, the quality of the ideas, and/or the number of ideas. In such a case, the control module 220 may utilize any suitable algorithm, historical data, occupant input, machine learning methods, and/or artificial intelligence techniques to determine the settings for a new environment inside the vehicle 102. The control module 220 may then control one or more vehicle systems 140 to change to the determined settings. As an example, the control module 220 may send an electronic signal to the vehicle 102 to adjust the temperature of the air conditioning to match the temperature that is determined to be conducive for idea incubation.

In one embodiment, the control module 220 may include instructions that, when executed by the processor(s) 110, cause the processor(s) 110 to provide an idea prompt to the occupant based at least one of a destination of the occupant, an origin of the occupant, an environment of the occupant, or a work project of the occupant. Upon determining that the occupant would like to participate in idea incubation, the control module 220 may output an idea prompt to the occupant visually and/or audibly. As such, the control module 220 may output the idea prompt using an audio speaker and/or a display screen. The audio speaker and/or the display screen may be part of the vehicle or a mobile device.

The control module 220 may determine the destination of the occupant based on a route in the navigation system of the vehicle 102, and/or historical information and habits. As an example, the control module 220 may determine that the occupant commutes from home to the office on weekday mornings. As such, the control module 220 may determine that the destination is the office when the occupant is commuting on a weekday morning. The control module 220 may also determine the destination based on input from the occupant. The control module 220 may request and receive the destination from the occupant.

The control module 220 may determine the origin of the occupant based on a route in the navigation system of the vehicle 102, and/or historical information and habits. As an example, the control module 220 may determine that the occupant commutes from home to the office on weekday mornings. As such, the control module 220 may determine that the origin is home when the occupant is commuting on a weekday morning. The control module 220 may also utilize a global positioning system to determine the origin. The control module 220 may also determine the origin based on input from the occupant. The control module 220 may request and receive the origin from the occupant.

The control module 220 may determine the environment of the location of the occupant, or more specifically, a current location of the occupant, using one or more sensors such as a global positioning system, camera(s) 126, LiDAR sensors 124, and/or radar sensors 123, microphones. Additionally and/or alternatively, the control module 220 may determine characteristics of the environment based on historical information and information from various databases.

The control module 220 may determine a work project of the occupant based on a scan of information on the occupant's mobile device and/or computer. The control module 220 may request and receive information about work projects from an email application, a work project status document or spreadsheet, and/or a to-do list application. The control module 220 may request and receive information about work projects from the occupant.

In one embodiment, the control module 220 may include instructions that, when executed by the processor(s) 110, cause the processor(s) 110 to provide options for occupant selection for refining the information related to the one or more ideas. As an example, the control module 220 may present an idea prompt to the occupant and request feedback from the occupant. The control module 220 may utilize any suitable algorithms including machine learning techniques and/or artificial intelligence methods to expand and/or develop ideas based on the idea prompts. The control module 220 may expand and/or develop the ideas by combining the idea prompt with a second idea prompt, by combining the idea prompts with other related ideas or even, unrelated ideas, or refining on the idea prompt by focusing or narrowing down to a specific characteristic of the idea prompt. As an example, the control module 220 may provide one or more of the ideas that have been combined or refined to the occupant such that the occupant may select one or more ideas to pursue, expand on, or develop. More generally, the control module 220 may communicate with the occupant about one or more ideas based on the idea prompts combined with one or more other related or unrelated ideas or based on specific characteristics of the idea prompts. In response to receiving feedback from the occupant, the control module 220 may update, expand, and/or refine the ideas.

In one embodiment, the control module 220 may include instructions that, when executed by the processor(s) 110, cause the processor(s) 110 to store information received from the occupant based on the one or more ideas. The information received refers to the ideas that the control module 220 and the occupant have developed and refined as stated above. Based on feedback from the occupant, the control module 220 may update, expand, and/or refine the ideas. The control module 220 may then store the ideas in a suitable data storage such as a database, a spreadsheet, a messaging application, or a word processing application.

In one embodiment, the control module 220 may include instructions that, when executed by the processor(s) 110, cause the processor(s) 110 to determine the effectiveness of the idea incubation process based on the engagement of the occupant. As an example, the control module 220 may request and receive feedback from the occupant. As another example, the control module 220 may monitor and record the number of ideas that the occupant expressed and/or developed. As another example, the control module 220 may monitor and record the response time of the occupant to idea prompts, the amount of time the occupant engaged, and/or the level of idea details provided by the occupant. The control module 220 may determine, using any suitable algorithm, whether an idea developed past the idea prompt, how much development had occurred, and/or how many related or unrelated ideas developed in the idea incubation session. As another example, the control module 220 may observe the expression of the occupant using, as an example, sensors 121, 122. The control module 220 may determine, based on the expression of the occupant whether the occupant was having a positive engagement, e.g., appeared to be happy while engaging or a negative engagement, e.g., appeared to be sad, angry, or tired while engaging.

The control module 220 may measure and collect information relating to the effectiveness of the incubation process using any suitable metrics and data storage devices, respectively. The control module 220 may transmit the information to the occupant using email, text message, or by populating a database, a spreadsheet, or a word processing application.

FIG. 3 illustrates a method 300 for idea incubation during a commute. The method 300 will be described from the viewpoint of the vehicle 102 of FIG. 1 and the idea incubation control system 100 of FIGS. 1 and 2. However, the method 300 may be adapted to be executed in any one of several different situations and not necessarily by the vehicle of FIG. 1 and/or the idea incubation control system 100 of FIGS. 1 and 2.

At step 310, the control module 220 may cause the processor(s) 110 to, in response to identifying one or more conditions where an occupant of a vehicle 102 is capable of commuting and participating in idea incubation, communicate with the occupant about one or more ideas. As previously mentioned, the one or more conditions may include an environmental condition. Further, the one or more conditions may include a condition of the occupant based on information collected from one or more sensors 121, 122 within the vehicle 102. The control module 220 may determine, based on environmental conditions such as a present location of the vehicle 102, traffic levels, the number of cyclists and pedestrians, and/or the type of road, whether the occupant is capable of participating in idea incubation. As an example, the control module 220 may determine, based on an expected travel route of the vehicle 102, an expected cognitive load and arousal level of the occupant. The control module 220 may make the determination based on the environmental conditions, vehicle conditions, and conditions of the occupant such driving experience of the occupant. The control module 220 may make the determination based on whether the occupant is driving or is a passenger in the vehicle 102.

As described above, the control module 220 may cause the processor(s) 110 to provide an idea prompt to the occupant based on at least one or more of a destination of the occupant, an origin of the occupant, an environment of the occupant, or a work project of the occupant. The idea prompt may be related to the one or more ideas. Also, as described above, the control module 220 may cause the processor(s) 110 to provide options for occupant selection for refining information received from the occupant based on the one or more ideas. As such, the control module 220 may provide one or more ideas to the occupant and the occupant may select from the one or more ideas which idea(s) to expand on or develop. The control module 220 may set up an environment inside the vehicle 102 conducive for idea incubation based on the occupant, conditions within the vehicle 102, conditions of the vehicle 102, and/or conditions surrounding the vehicle 102.

At step 320, the control module 220 230 may cause the processor(s) 110 to store information received from the occupant based on the one or more ideas. As an example and as previously disclosed, the control module 220 may store the information in a data storage unit, a database, a spreadsheet, and/or a word processing application.

FIG. 1 will now be discussed in full detail as an example environment within which the system and methods disclosed herein may operate. In some instances, the vehicle 102 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from an occupant (e.g., human driver). In one or more arrangements, the vehicle 102 can be a conventional vehicle that is configured to operate in only a manual mode.

In one or more embodiments, the vehicle 102 is an autonomous vehicle. As used herein, “autonomous vehicle” refers to a vehicle that operates in an autonomous mode. “Autonomous mode” refers to navigating and/or maneuvering the vehicle 102 along a travel route using one or more computing systems to control the vehicle 102 with minimal or no input from a human driver. In one or more embodiments, the vehicle 102 is highly automated or completely automated. In one embodiment, the vehicle 102 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 102 along a travel route.

The vehicle 102 can include one or more processors 110. In one or more arrangements, the processor(s) 110 can be a main processor of the vehicle 102. For instance, the processor(s) 110 can be an electronic control unit (ECU). The vehicle 102 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 260-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

The one or more data stores 115 can include sensor data 119. In this context, “sensor data” means any information about the sensors that the vehicle 102 is equipped with, including the capabilities and other information about such sensors. As will be explained below, the vehicle 102 can include the sensor system 120. The sensor data 119 can relate to one or more sensors of the sensor system 120. As an example, in one or more arrangements, the sensor data 119 can include information on one or more vehicle sensors 121 and/or environment sensors 122 of the sensor system 120.

In some instances, at least a portion of the map data 116 and/or the sensor data 119 can be located in one or more data stores 115 located onboard the vehicle 102. Alternatively, or in addition, at least a portion of the map data 116 and/or the sensor data 119 can be located in one or more data stores 115 that are located remotely from the vehicle 102.

As noted above, the vehicle 102 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that an occupant or a system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 102 (including any of the elements shown in FIG. 1). The sensor system 120 can acquire data of at least a portion of the internal environment as well as the external environment of the vehicle 102 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 102 itself. In one or more arrangements, the vehicle sensor(s) 121 can be configured to detect, and/or sense position and orientation changes of the vehicle 102, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 102. In one or more arrangements, the vehicle sensor(s) 121 can include a speedometer to determine a current speed of the vehicle 102.

Alternatively, or in addition, the sensor system 120 can include one or more environment sensors 122 configured to acquire, and/or sense data inside the vehicle as well as around the vehicle. Sensor data inside the vehicle can include information about one or more occupants in the vehicle cabin and any other objects of interest. Sensor data around the vehicle can include information about the external environment in which the vehicle is located or one or more portions thereof.

As an example, the one or more environment sensors 122 can be configured to detect, quantify and/or sense objects in at least a portion of the internal and/or the external environment of the vehicle 102 and/or information/data about such objects.

In the internal environment of the vehicle 102, the one or more environment sensors 122 can be configured to detect, measure, quantify, and/or sense human occupants inside the vehicle 102 and the facial expressions of the occupants. In the external environment, the one or more environment sensors 122 can be configured to detect, measure, quantify, and/or sense objects in the external environment of the vehicle 102, such as, for example, lane markers, signs, traffic lights, traffic signs, lane lines, crosswalks, curbs proximate the vehicle 102, off-road objects, other vehicles, cyclists, pedestrians, electronic roadside devices, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LiDAR sensors 124, one or more sonar sensors 125, one or more cameras 126, one or more audio sensors 127, one or more air quality sensors 128, and/or one or more light sensors 129. In one or more arrangements, the one or more cameras 126 can be high dynamic range (HDR) cameras or infrared (IR) cameras. The audio sensor(s) 127 can be microphones and/or any suitable audio recording devices. Any sensor in the sensor system 120 that is suitable for detecting and observing humans and/or human facial expression can be used inside the vehicle 102 to observe the occupants. Additionally, the sensor system 120 can include one or more air quality sensors 128 for detecting allergens such as pollen, dust, and/or fur in the air inside the vehicle. The sensor system 120 can include one or more light sensors 129 for measuring light levels inside the vehicle.

The vehicle 102 can include an input system 130. An “input system” includes any device, component, system, element or arrangement or groups thereof that enable information/data to be entered into a machine. The input system 130 can receive an input from an occupant (e.g., a driver or a passenger). The vehicle 102 can include an output system 135. An “output system” includes any device, component, or arrangement or groups thereof that enable information/data to be presented to an occupant (e.g., a person, a vehicle passenger, etc.) such as a display interface.

The vehicle 102 can include one or more vehicle systems 140. Various examples of the one or more vehicle systems 140 are shown in FIG. 1. However, the vehicle 102 can include more, fewer, or different vehicle systems 140. It should be appreciated that although particular vehicle systems are separately defined, each or any of the systems or portions thereof may be otherwise combined or segregated via hardware and/or software within the vehicle 102. The vehicle 102 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 102 and/or to determine a travel route for the vehicle 102. The navigation system 147 can include one or more mapping applications to determine a travel route for the vehicle 102. The navigation system 147 can include a global positioning system, a local positioning system or a geolocation system.

The vehicle 102 can include one or more autonomous driving systems 160. The autonomous driving system 160 can include one or more devices, applications, and/or combinations thereof, now known or later developed, configured to control the movement, speed, maneuvering, heading, direction, etc. of the vehicle 102. The autonomous driving system 160 can include one or more driver assistance systems such as a lane keeping system, a lane centering system, a collision avoidance system, and/or a driver monitoring system.

The autonomous driving system(s) 160 can be configured to receive data from the sensor system 120 and/or any other type of system capable of capturing information relating to the vehicle 102 and/or the external environment of the vehicle 102. In one or more arrangements, the autonomous driving system(s) 160 can use such data to generate one or more driving scene models. The autonomous driving system(s) 160 can determine position and velocity of the vehicle 102. The autonomous driving system(s) 160 can determine the location of obstacles, obstacles, or other environmental features including traffic signs, trees, shrubs, neighboring vehicles, pedestrians, etc.

The autonomous driving system(s) 160 can be configured to receive, and/or determine location information for obstacles within the external environment of the vehicle 102 for use by the processor(s) 110, and/or one or more of the modules described herein to estimate position and orientation of the vehicle 102, vehicle position in global coordinates based on signals from a plurality of satellites, or any other data and/or signals that could be used to determine the current state of the vehicle 102 or determine the position of the vehicle 102 with respect to its environment for use in either creating a map or determining the position of the vehicle 102 in respect to map data.

The autonomous driving system(s) 160 either independently or in combination with the idea incubation control system 100 can be configured to determine travel path(s), current autonomous driving maneuvers for the vehicle 102, future autonomous driving maneuvers and/or modifications to current autonomous driving maneuvers based on data acquired by the sensor system 120, driving scene models, and/or data from any other suitable source such as determinations from the sensor data 119. “Driving maneuver” means one or more actions that affect the movement of a vehicle. Examples of driving maneuvers include accelerating, decelerating, braking, turning, moving in a lateral direction of the vehicle 102, changing travel lanes, merging into a travel lane, and/or reversing, just to name a few possibilities. The autonomous driving system(s) 160 can be configured to implement determined driving maneuvers. The autonomous driving system(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system(s) 160 can be configured to execute various vehicle functions and/or to transmit data to, receive data from, interact with, and/or control the vehicle 102 or one or more systems thereof (e.g., one or more of vehicle systems 140).

The processor(s) 110 and/or the autonomous driving system(s) 160 can be operatively connected to communicate with the various vehicle systems 140 and/or individual components thereof. For example, the processor(s) 110 and/or the autonomous driving system(s) 160 can be in communication to send and/or receive information from the various vehicle systems 140 to control the movement, speed, maneuvering, heading, direction, etc. of the vehicle 102. The processor(s) 110 and/or the autonomous driving system(s) 160 may control some or all of these vehicle systems 140 and, thus, may be partially or fully autonomous.

The processor(s) 110 and/or the autonomous driving system(s) 160 may be operable to control the navigation and/or maneuvering of the vehicle 102 by controlling one or more of the vehicle systems 140 and/or components thereof. As an example, when operating in an autonomous mode, the processor(s) 110 and/or the autonomous driving system(s) 160 can control the direction and/or speed of the vehicle 102. As another example, the processor(s) 110 and/or the autonomous driving system(s) 160 can activate, deactivate, and/or adjust the parameters (or settings) of the one or more driver assistance systems. The processor(s) 110 and/or the autonomous driving system(s) 160 can cause the vehicle 102 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 102 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving system(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 102 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the occupant's computer, partly on the occupant's computer, as a stand-alone software package, partly on the occupant's computer and partly on a remote computer, or entirely on the remote computer or server. In the latter scenario, the remote computer may be connected to the occupant's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
in response to identifying one or more conditions where an occupant of a vehicle is capable of commuting and participating in idea incubation, communicate with the occupant about one or more ideas; and
store information received from the occupant based on the one or more ideas.

2. The system of claim 1, wherein the one or more conditions include an environmental condition.

3. The system of claim 1, wherein the machine-readable instructions further include machine-readable instructions that, when executed by the processor, cause the processor to:
determine, based on an expected travel route of the vehicle, an expected cognitive load and arousal level of the occupant; and
when the expected cognitive load and arousal level of the occupant is below a threshold, communicate with the occupant about the one or more ideas.

4. The system of claim 1, wherein the one or more conditions include a condition of the occupant based on information collected from a sensor mounted within the vehicle.

5. The system of claim 1, wherein the machine-readable instructions further include machine-readable instructions that, when executed by the processor, cause the processor to:
set up an environment inside a vehicle conducive for idea incubation.

6. The system of claim 1, wherein the machine-readable instructions further include machine-readable instructions that, when executed by the processor, cause the processor to provide an idea prompt to the occupant based at least one of:
a destination of the occupant;
an origin of the occupant;
an environment of the occupant; or
a work project of the occupant.

7. The system of claim 1, wherein the machine-readable instructions further include machine-readable instructions that, when executed by the processor, cause the processor to provide options for occupant selection for refining the information.

8. A method comprising:
in response to identifying one or more conditions where an occupant of a vehicle is capable of commuting and participating in idea incubation, communicating with the occupant about one or more ideas; and
storing information received from the occupant based on the one or more ideas.

9. The method of claim 8, wherein the one or more conditions include an environmental condition.

10. The method of claim 8, further comprising:
determining, based on an expected travel route of the vehicle, an expected cognitive load and arousal level of the occupant; and
when the expected cognitive load and arousal level of the occupant is below a threshold, communicating with the occupant about the one or more ideas.

11. The method of claim 8, wherein the one or more conditions include a condition of the occupant based on information collected from a sensor mounted within the vehicle.

12. The method of claim 8, further comprising:
setting up an environment inside the vehicle conducive for idea incubation.

13. The method of claim 8, further comprising:
providing an idea prompt to the occupant based at least one of:
a destination of the occupant;
an origin of the occupant;
an environment of the occupant; or
a work project of the occupant.

14. The method of claim 8, further comprising:
providing options for occupant selection for refining the information.

15. A non-transitory computer-readable medium including machine-readable instructions that, when executed by a processor, cause the processor to:
in response to identifying one or more conditions where an occupant of a vehicle is capable of commuting and participating in idea incubation, communicate with the occupant about one or more ideas; and
store information received from the occupant based on the one or more ideas.

16. The non-transitory computer-readable medium of claim 15, wherein the one or more conditions include an environmental condition.

17. The non-transitory computer-readable medium of claim 15, wherein the machine-readable instructions further include machine-readable instructions that, when executed by the processor, cause the processor to:
determine, based on an expected travel route of the vehicle, an expected cognitive load and arousal level of the occupant; and
when the expected cognitive load and arousal level of the occupant is below a threshold, communicate with the occupant about the one or more ideas.

18. The non-transitory computer-readable medium of claim 15, wherein the one or more conditions include a condition of the occupant based on information collected from a sensor mounted within the vehicle.

19. The non-transitory computer-readable medium of claim 15, wherein the machine-readable instructions further include machine-readable instructions that, when executed by the processor, cause the processor to:
set up an environment inside a vehicle conducive for idea incubation.

20. The non-transitory computer-readable medium of claim 15, wherein the machine-readable instructions further include machine-readable instructions that, when executed by the processor, cause the processor to provide an idea prompt to the occupant based at least one of:
a destination of the occupant;
an origin of the occupant;
an environment of the occupant; or
a work project of the occupant.
